(19) United States
(12) Patent Application Publication
(10) Pub. No.: US 2009/0149323 A1
(43) Pub. Date: Jun. 11, 2009

(54) METHOD FOR PRODUCING MONOLITHIC CATALYST FOR EXHAUST GAS PURIFICATION AND MONOLITHIC CATALYST

(76) Inventors: Tomoaki SUNADA, Toyota-shi (JP); Yoshihide Segawa, Kariya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/326,140

(22) Filed: Dec. 2, 2008

(30) Foreign Application Priority Data
Dec. 10, 2007 (JP) 2007-318222

(51) Int. Cl. B01J 23/648

(52) U.S. Cl. 502/334

(57) ABSTRACT

It is to provide a method for producing a monolithic catalyst for exhaust gas purification, which can effectively perform exhaust gas purification in accordance with the shape of an exhaust manifold of a catalytic converter, and to provide a monolithic catalyst. The monolithic catalyst has a catalyst coat layer in the axial center region of a substrate, which includes the axial center of an exhaust pipe and has a lower end corresponding to a projected plane of the cross-section of the exhaust pipe, in an amount larger than in a peripheral region other than the axial center region of the substrate. The process of forming the catalyst coat layer which has this distribution of coating amount comprises maintaining a slurry for forming the catalyst coat layer in an approximately truncated conical shape, bringing one end of the monolithic catalyst substrate into close contact with a horizontal side of the slurry, and sucking once the slurry from the other end of the substrate.

### INCORPORATION BY REFERENCE

The present invention is based on Japanese Patent Application No. 2007-318,222, filed on Dec. 10, 2007, the entire contents of which are incorporated herein by reference.

### BACKGROUND OF THE INVENTION

1. Field of the Invention

The present invention relates to a monolithic catalyst for exhaust gas purification. Specifically, the present invention relates to a method for producing a monolithic catalyst, in which the catalyst coat layer of the catalyst is formed in such a manner that the amount of coating of the catalyst coat layer is large in the central region of the catalyst and small in the peripheral region, and to a monolithic catalyst produced thereby.

2. Description of the Related Art

A catalyst for automobile exhaust gas purification is mounted in a catalytic converter located in an exhaust line between an exhaust manifold and a muffler. In monolithic catalysts used in the prior art, the distribution of the catalytic components is substantially uniform throughout the monolithic catalysts. However, because the monolithic catalyst is generally disposed downstream of a manifold having a cross-sectional area smaller than that thereof, the flow rate of exhaust gas in the monolithic catalyst is high in the central region and low in the peripheral region. For this reason, the amount of exhaust gas that is treated by the catalytic components is large in the central region with high flow rate and small in the peripheral region. Accordingly, there are problems in that, in the central region, deterioration in the function of the catalytic components becomes fast, whereas, in the peripheral region, the catalytic components are excessively supplied compared to the throughput volume of exhaust gas, and thus the catalytic components are not effectively utilized.

Patent Reference 1 discloses an exhaust gas purification system in which the distribution of concentration of catalytic noble metals was varied depending on the temperature distribution or gas flow distribution in an exhaust gas purification catalyst.

In this exhaust gas purification system, as shown in FIG. 10, an exhaust gas purification catalyst 103 comprising a catalytic noble metal-containing catalyst coat layer formed on the surface of a monolithic carrier is disposed in an approximately cylindrical housing placed in an exhaust line 101. In the exhaust gas purification catalyst 103, a high-concentration catalytic noble metal portion 104, which may have an increased concentration of catalytic noble metals and has an approximately T-shaped longitudinal section, is formed at a portion having suitable thickness slightly downstream of an exhaust gas inlet end and around an axial center region downstream of that portion. Meanwhile, in portions other than the high-concentration catalytic noble metal portion 104, the concentration of catalytic noble metals is lower than that in the portion 104, and low-concentration catalytic noble metal portions 105 and 106 are formed.

However, a process for producing the exhaust gas purification catalyst 103 having such a structure is very complicated, and thus the exhaust gas purification catalyst 103 cannot necessarily be satisfied in view of productivity and cost.

Furthermore, Patent Reference 2 discloses a system for producing a monolithic catalyst for exhaust gas purification, in which a resistive material that does not exceed the cross-section of a monolithic carrier is disposed in a suction unit in such a manner that it is disposed below the lower side of the monolithic carrier. The resistive material is used in a process of injecting catalyst slurry and removing an excess of the catalyst slurry. According to the production system, the resistive material is disposed in the suction unit, such that it can change the flow of excessive catalyst slurry that is removed. Thus, in the central region in which the flow of exhaust gas is large, the coat layer can be formed in a large amount, and in the peripheral region in which the flow of exhaust gas is small, the coat layer can be formed in a small amount.

However, in the prior art disclosed in Patent Reference 2, there is a problem in that, because an excess of catalyst-containing slurry is removed by suction, the ratio of catalytic noble metals in the resulting catalyst product is low.

[Patent Reference 1] Japanese Patent Laid-Open Publication No. 61-46252

[Patent Reference 2] Japanese Patent Laid-Open Publication No. 2000-202304

### SUMMARY OF THE INVENTION

Therefore, the present invention has been made in view of the above-mentioned problems, and an object of the present invention is to provide a method for producing a monolithic catalyst for exhaust gas purification, which can effectively perform exhaust gas purification in accordance with the shape of an exhaust manifold, and to provide a monolithic catalyst.

To achieve the above object, the present invention provides a method for producing a monolithic catalyst, comprising a process of forming a catalyst coat for carrying catalytic components on the inner surfaces of cells of a substrate, which is disposed downstream of an exhaust pipe for discharging exhaust gas, and which includes a large number of cells extending in the axial direction and has a rod shape, wherein the process of forming the catalyst coat comprises forming a catalyst coat layer in the axial center region of the substrate, which includes the axial center of the exhaust pipe and has a lower end corresponding to the projected plane of the cross-section of the exhaust pipe, in an amount larger than in a peripheral region other than the axial center region of the substrate.

In the inventive method for producing the monolithic catalyst for exhaust gas purification, the process of forming the catalytic coat preferably comprises maintaining a slurry for forming the catalyst coat layer in an approximately truncated conical shape that has an upper side corresponding to the projected plane of the cross-section of the exhaust pipe and a lower side corresponding to the projected plane of the cross-section of the substrate, bringing one end of the substrate into close contact with the lower side of the slurry and sucking the slurry from the other end of the substrate.

Alternatively, the process of forming the catalyst coat may comprise disposing a resistive material, which restricts the flow of slurry, between the slurry for forming the catalyst coat layer and one end of the substrate, and sucking the slurry from the other end of the substrate.

In the process of forming the catalyst coat, the resistive material may be a net material having a hole portion resembling the projected plane of the cross-section of the exhaust pipe. Alternatively, the resistive material may be a plate material, which has a hole portion resembling the projected plane of the cross-section of the exhaust pipe and can be separated into parts depending on the diameter of the hole portion.

In the inventive method for producing the monolithic catalyst for exhaust gas purification, the viscosity of the slurry is preferably 2000-10000 mP·s, and negative suction pressure for sucking the slurry is preferably 1-30 atm.

The monolithic catalyst for exhaust gas purification according to the present invention is produced according to any one of the above-described methods.

### EFFECT OF THE INVENTION

According to the inventive method for producing the monolithic catalyst for exhaust gas purification, a catalyst coat layer can be formed in the axial center region of the substrate, which includes the axial center of the exhaust pipe and has a lower end corresponding to the projected plane of the cross-section of the exhaust pipe, in an amount larger than in a peripheral region other than the axial center region of the substrate. Thus, catalytic components can be effectively carried in accordance with the cross-section of the exhaust pipe of the catalytic converter. In addition, the desired catalyst coat layer can be formed by sucking a necessary amount of slurry in a one-step suction process, and thus the formation of the catalyst coat layer in the substrate is achieved in a simple manner.

With respect to the monolithic catalyst obtained according to the present invention, in the axial center region in which the flow rate of exhaust gas is high, the exhaust gas purification performance is good, because the amount of catalytic components carried to the axial central region is large. Also, in the peripheral region in which the flow rate of exhaust gas is low, high purification performance can be achieved, even though the amount of catalytic components carried thereto is small.

Therefore, the monolithic catalyst of the present invention can show high purification performance compared to the prior art, because catalytic noble metals can be effectively utilized without waste, when the catalytic components were carried in the same amount as in the prior art. In addition, the monolithic catalyst of the present invention can show the same purification performance as the prior monolithic catalyst, even when the amount of catalytic components therein is lower than that in the prior monolithic catalyst.

### BRIEF DESCRIPTION OF THE DRAWINGS

The above and other objects and features of the present invention will become apparent from the following description of a preferred embodiment, given in conjunction with the accompanying drawings, in which:

FIG. 1 is a cross-sectional schematic view showing the structure of a monolithic catalyst according to the present invention;

FIG. 2 is a cross-sectional schematic view showing the distribution of coating amount in a monolithic catalyst obtained in a first embodiment;

FIG. 3 is a cross-sectional schematic view showing examples of casings used in the first embodiment, FIG. 3(a) showing an example of a casing, which is used when the diameter of an exhaust pipe is large, FIG. 3(b) showing an example of a casing, which is used when the diameter of an exhaust pipe is small;

FIG. 4 is a view explaining a process of forming a catalyst coat layer in the first embodiment;

FIG. 5 is a view explaining a process of forming a catalyst coat layer in the first embodiment;

FIG. 6 is a cross-sectional schematic view showing the distribution of coating amount of a catalyst coat layer in a catalytic converter in which an exhaust pipe is eccentric;

FIG. 7 illustrates a process of forming a catalyst coat layer in a second embodiment, FIG. 7(a) being a cross-sectional view showing the overall construction, FIG. 7(b) showing an example of a net material, FIG. 7(c) showing an example of a plate material;

FIG. 8 is a schematic diagram showing the distribution of coating amount of the catalyst coat layer in the monolithic catalyst obtained in the second embodiment;

FIG. 9 is a view explaining a process of forming a catalyst coat layer in a modified embodiment of the second embodiment, FIG. 9(a) being a cross-sectional view showing the overall construction, FIG. 9(b) being a schematic diagram showing the cross-section of the monolithic catalyst; and

FIG. 10 is a cross-sectional schematic view showing an example of a prior monolithic catalyst.

### DETAILED DESCRIPTION OF THE PREFERRED EMBODIMENTS

Various embodiments of the present invention will now be described in detail with reference to the accompanying drawings.

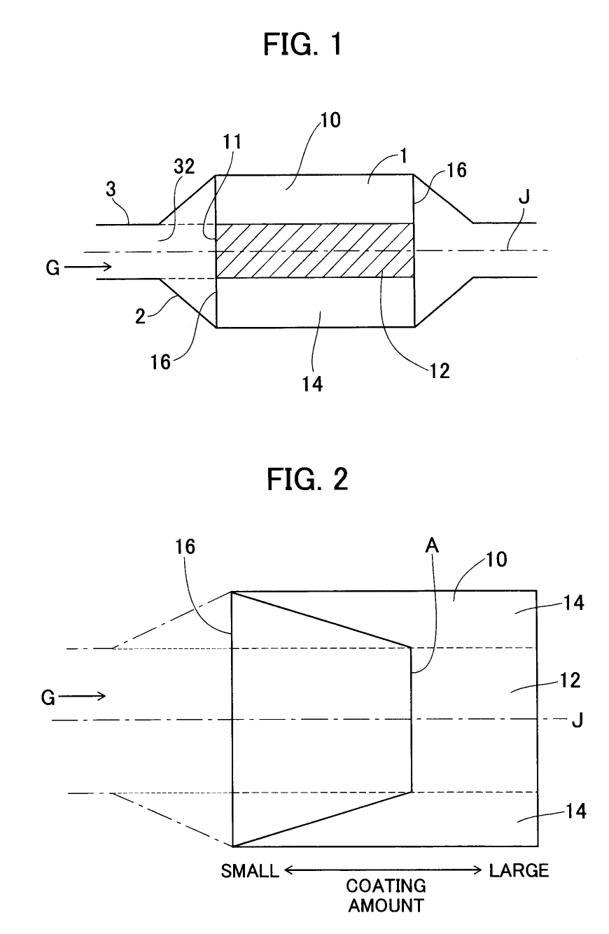

As shown in FIG. 1, a monolith catalyst 1 of the present invention is disposed downstream of an exhaust pipe 3 that discharges exhaust gas G. In the monolithic catalyst 1 of the present invention, a catalyst coat layer is formed in the axial center region 12 of a substrate 10, which includes the axial center J of the exhaust pipe 3 and has a lower end corresponding to the projected plane 11 of the cross-section 32 of the exhaust pipe 3, in an amount larger than that in a peripheral region 14 other than the axial center region 12. Thus, the monolithic catalyst 1 may carry the catalytic components in the axial center region 12 in an amount larger than that in the peripheral region 14.

Herein, the monolithic catalyst substrate 10 is a honeycomb structure that has a large number of cells (100-600 cells/in²) extending in the flow direction of the exhaust gas, and the shape thereof is a cylindrical shape (a circular cylindrical shape, a rectangular cylindrical shape, etc.; a shape suitable for the internal shape of the catalytic converter 2 in which the monolithic catalyst is placed). In addition, the monolithic catalyst substrate 10 is generally made of cordierite, but may also be made of mullite, spinel, etc.

Preferred embodiments of a method for producing the monolithic catalyst having the above-described structure will now be described.

### First Embodiment

A process of forming a catalyst coat in this embodiment comprises maintaining a catalyst coat layer-forming slurry in an approximately truncated conical shape having an upper end corresponding to the projected plane of the cross-section of the exhaust pipe and a lower end corresponding to the projected plane of the cross-section of the substrate, bringing one end of the substrate into close contact with the lower side of the slurry, and sucking the slurry from the other end of the substrate. In this catalyst coat layer-forming process, the whole amount of the slurry is sucked once according to the order of the following steps (1)-(7) to form an approximately trapezoidal cross-sectional distribution A of coating amount (as shown in FIG. 2) in the substrate 10, unlike the prior catalyst coat layer-forming process in which an excess of slurry is removed by suction.

(Step 1) First, slurry containing catalyst coat layer components is prepared. The slurry may contain, but are not limited to, cesium (Ce), zirconium (Zr), aluminum (Al), neodymium (Nd), yttrium (Y), praseodymium (Pr), gadolinium (Gd), or oxides thereof, which are generally used. If necessary, the viscosity of the slurry may be increased by adding a thickener such as hydroxyethylcellulose to the slurry or increasing the solid content of the slurry. The viscosity of the slurry is preferably 2000-10000 mPa·s as measured by a B-type viscometer (Tokimec Inc). At less than 2000 mPa·s, the thickness of the catalyst coat layer becomes non-uniform, and at more than 10000 mPa·s, the slurry closes the cells of the substrate. More preferably, the viscosity of the slurry is 3000-5000 mPa·s.

(Step 2) Then, a casing having an inner circumferential shape resembling the desired distribution shape of the catalyst coat layer is prepared. For example, in an approximately truncated conical casing, the opening 42a has the same shape as the cross-section 16 of the substrate 10, and the bottom has the same shape as the cross-section 32 of the exhaust pipe 3. In addition, the casing has substantially the same inner volume as the whole amount of slurry required to form the catalyst coat layer.

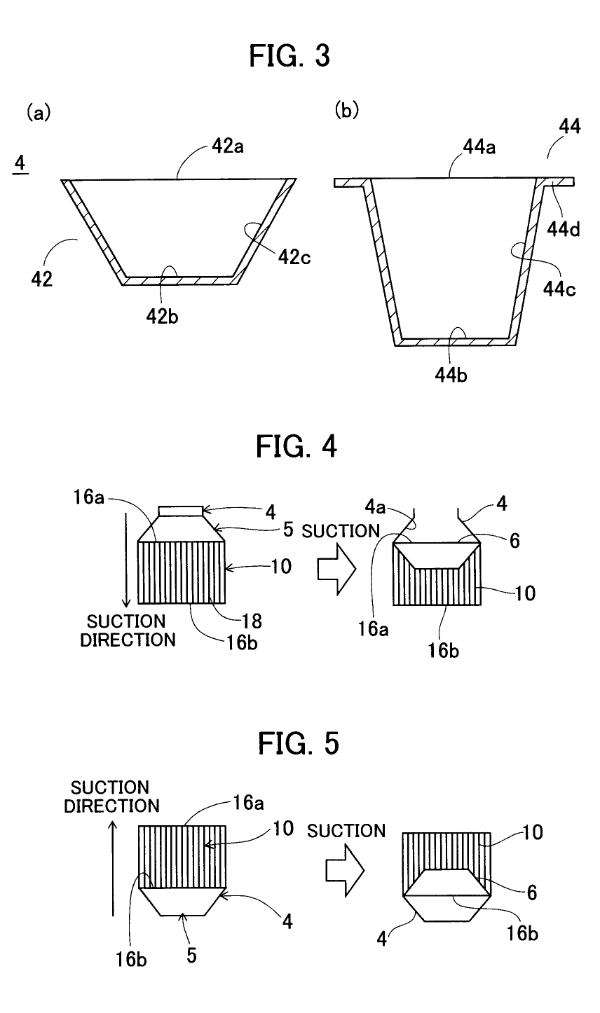

FIG. 3 is a cross-sectional view showing examples of a casing 4. In a casing 42 of FIG. 3(a), the shape of the opening 42a approximately resembles the cross-section 16 of the substrate 10, and the shape of the bottom 42b approximately resembles the projected plane of the cross-section 32 of the exhaust pipe. Also, the inner volume of the casing is substantially equal to the whole amount of slurry required to form the catalyst coat layer. A casing 44 in FIG. 3(b) is preferably used when the cross-sectional area of the exhaust pipe 3 greatly differs from the cross-sectional area of the substrate 10 (for example, the exhaust pipe 3 is thin). In the casing 44, the upper side 44a has a shape approximately resembling the cross-section of the catalyst substrate, but the casing 44 comprises a flange 44d at the outer circumferential portion. The flange 44d serves to mask the outer circumferential region of the substrate cross-section 16, in which the exhaust gas does not flow. Other details are the same as the casing 42. In addition, to facilitate the suction of the slurry, through-holes may be formed in the bottom or wall of the casing 4.

(Step 3) The slurry prepared in step 1 is filled in the casing 4 prepared in step 2. Because the casing 4 has an inner volume approximately equal to the whole amount of slurry required to form the catalyst coat layer, the slurry is filled in the casing 4 full.

(Step 4) One end of the monolithic catalyst substrate 10 is brought into close contact with the surface of the slurry 5 filled in the casing 4. Herein, the arrangement of the casing 4 is selected depending on the slurry 5. For example, if the viscosity of the slurry is more than 3000 mPa·s, as shown in FIG. 4, the casing 4 having the slurry 5 filled therein is mounted upside down on the upper end 16a of the catalyst substrate 10. On the other hand, if the viscosity of the slurry is less than 3000 mPa·s, as shown in FIG. 5, the lower end 16b of the substrate 10 is brought into close contact with the surface of the slurry 5 located under the substrate 10.

(Step 5) Subsequently, the slurry 5 is sucked from the other end (for example, the lower end 16b in FIG. 4; hereinafter the same) of the substrate 10. Because the slurry 5 is sucked while adhering to the inner surfaces 18 of the cells, as shown in the right figure of FIG. 4, a catalyst coat layer 6 in the substrate 10 is formed in a reversed shape with respect to one end 16a of the substrate 10 which is in close contact with the slurry 5 filled in the casing 4. As a result, the catalyst coat layer 6 is formed in an approximately trapezoidal shape that becomes narrower from the inlet end 16a of the exhaust gas G downward in the longitudinal section of the monolithic catalyst 1 including the axial center J, and it is not formed downstream of the trapezoidal shape.

Herein, the suction is preferably carried out at 1-30 atm for 1-40 seconds. If the negative suction pressure is less than 1 atm, the high-viscosity slurry cannot be completely sucked, and if the negative suction pressure exceeds 30 atm, the catalyst coat layer greatly deviates from the reversed shape. More preferably, the negative suction pressure is 5-20 atm. Also, the suction is preferably carried out for the shortest possible time. If the suction is carried out for 40 seconds or more, the distribution of coating amount resembling the inner circumferential shape of the casing cannot be achieved. More preferably, the suction time is 1-5 seconds.

(Step 6) Then, the monolithic catalyst substrate 10 having the slurry in the distribution shape is dried and calcined to form a catalyst coat layer 6 on the inner surface 18 of the cells of the substrate 10. Herein, the drying or calcining process may be carried out according to a conventional method.

(Step 7) The monolithic catalyst substrate 10 having the catalyst coat layer 6 formed therein is soaked in a solution containing a catalytic component to impregnate the catalytic component into the catalyst coat layer. Subsequently, the substrate 10 having the catalytic components impregnated in the catalyst coat layer 6 is dried and calcined, whereby the catalytic components are loaded on the catalyst coat layer 6, thus obtaining the desired monolithic catalyst 1 for exhaust gas purification. Herein, the method of loading the catalytic components on the catalyst coat layer 6 is not limited to any particular method and can be carried out according to any conventional method.

In addition, the catalytic component-containing solution may be incorporated into the coat layer component-containing slurry in step 1, and the formation of the catalyst coat layer 6 and the loading of the catalytic component may be simultaneously carried out.

Examples of the catalytic component that can be used in the present invention include those known in the prior art, for example, noble metals such as platinum (Pt), palladium (Pd), iridium (Ir), ruthenium (Ru), rhodium (Rh) or osmium (Os), or metals such as chromium (Cr), nickel (Ni), vanadium (V) or copper (Cu).

The catalytic components are uniformly loaded onto the catalyst coat layer 6. Thus, according to this embodiment, the catalytic components can be loaded in the axial center region 12 (where the amount of coating of the catalyst coat layer 6 is large) in an amount larger than that in the peripheral region 14 (where the coating amount of the catalyst coat layer is small), and it is possible to obtain the monolithic catalyst 1 for exhaust gas purification in which all the loaded catalytic components effectively function.

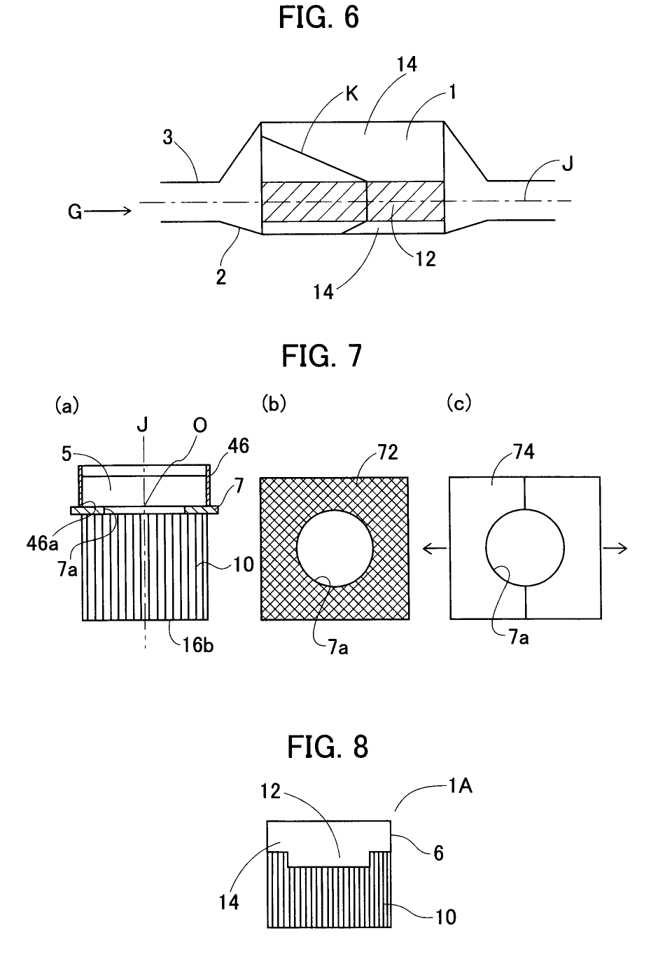

Herein, the axial center region 12 generally means the axial center region of the monolithic catalyst 1 as shown in FIG. 1, but is not limited thereto. If the catalytic converter 2 is arranged eccentrically with respect to the monolithic catalyst 1 as shown in FIG. 6, the axial center region means the axial center J of the exhaust pipe 3 of the catalytic converter 2, that is, the region in which the flow rate of exhaust gas is the highest. In this case, a catalyst coat layer 6 can be formed in which the distribution of coating amount is eccentric downward as indicated by “K” in FIG. 6.

### Second Embodiment

In this embodiment, between the slurry for forming the catalyst coat layer and one end of the substrate, a resistive material that restricts the introduction of the slurry into the peripheral region is disposed, such that the slurry is sucked from the other end of the substrate.

FIG. 7 shows the schematic construction of a process of forming the catalyst coat layer according to this embodiment. This embodiment is carried out in the order of the following steps.

(Step 1) First, the same slurry as prepared in the first embodiment, a tub-shaped casing 46 including a passage 46a having a shape approximately equal to the cross-section 16 of the substrate, and a resistive material 7 having a hole portion 7a formed in a portion corresponding to the axial center region 12 of the substrate 10, are prepared. As the resistive material, a net material 72 having a suitable hole size, or a plate material 74 that can be separated into parts depending on the diameter of the hole portion 7a, may be used.

(Step 2) Then, the resistive material 7 is disposed between the opening 46a of the casing 46 and one end 16a of the substrate 10. Herein, the resistive material 7 is disposed such that the center O of the hole portion 7a coincides with the axial center J of the exhaust pipe 3. FIG. 7 is a case in which the viscosity of the slurry is more than 3000 mPa·s. If the viscosity of the slurry is less than 3000 mPa·s, the resistive material 7 and the casing 46 containing the slurry 5 filled therein are sequentially arranged on the lower end 16b of the substrate 10 as described in the first embodiment.

(Step 3) The whole amount of the slurry 5 required to form a catalyst coat layer is filled in the casing 46.

(Step 4) Subsequently, the slurry 5 is sucked from the other end 16b of the substrate 10 in the same manner as in the first embodiment. If the resistive material 7 is the separable plate material 74, the plate material 74 is separated and removed in the right and left directions at a specific time (for example, 0.5-1 second) after the start of suction, and the restriction of invasion of the slurry 5 into the peripheral region is removed.

Other steps can be carried out in the same manner as in the first embodiment. In this way, as shown in FIG. 8, a monolithic catalyst 1A can be obtained in which the amount of the catalyst coat layer is large in the axial center region 12 and small in the peripheral region 14.

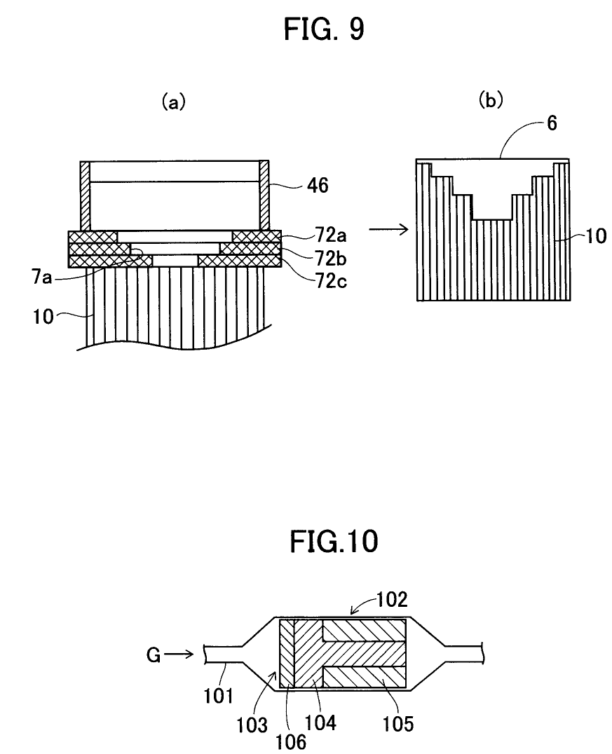

Meanwhile, if the resistive material 72 is the net material, as shown in FIG. 9, it may consist of a stack of a plurality of net materials 72a, 72b and 72c having different diameters 7a of the hole portion 7a. Specifically, the resistive material is constructed such that the flow resistance of the slurry 5 increases toward the periphery. By using this plurality of layers of the net material 72, the distribution of coating amount of the catalyst coat layer 6 as shown in FIG. 9(b) can be obtained, and a monolithic catalyst 1B can be obtained in which all the catalytic components more efficiently function.

### EXAMPLES

Hereinafter, the present invention will be described in detail with reference to specific examples.

### Example 1

(1) Formation of Catalyst Coat Layer

To a mixed aqueous solution of 300 g of alumina sol (alumina content: 50 wt % (hereinafter % is % by weight)), 125 g (40%) of aqueous aluminum sulfate solution and 135 ml of water, 36 g of alumina powder as a thickener was added, and the mixture was stirred to prepare a slurry for forming a catalyst coat layer. The viscosity of the slurry was 3300 mPa·s as measured by a B-type viscometer (Tokimec Inc).

Then, a truncated conical casing, which has a bottom diameter (equal to the diameter of an exhaust pipe of a catalytic converter; hereinafter the same) of 58.5 mm, a top diameter of 103 mm and a depth of 50 mm and is open at the top and closed at the bottom, is completely filled with the slurry prepared as described above. Namely, the inner volume (120 ml) of the casing was approximately equal to the whole volume of a catalyst coat layer formed in a monolithic catalyst.

Subsequently, the casing containing the slurry filled therein is mounted upside down on the upper end of a perpendicularly arranged cylindrical monolith catalyst substrate (outer diameter: 103 mm; length: 105 mm; 400 cells/in²; made of cordierite). Then, the slurry was sucked from the lower end of the monolithic catalyst substrate at a negative suction pressure of 20 atm for 2 seconds, such that the whole amount of the slurry was attached to the inner surface of the cells of the monolithic catalyst substrate by a one-step suction process.

Then, the catalyst substrate having the catalyst coat layer formed therein was dried at 250° C. for 8 hours and calcined at 500° C. for 2 hours, thus forming a catalyst coat layer having an approximately truncated cone-shaped coating amount distribution which was symmetrical to the inner circumference of the casing with respect to the upper end of the substrate. In addition, the formed catalyst coat layer had a coating amount of 270 g/L (weight per volume (L) of the catalyst substrate; hereinafter the same).

(2) Loading of Catalytic Components

The catalyst substrate 1 having the catalyst coat layer formed therein was soaked in 14.7 g of dinitroamine platinum solution (meaning a solution providing a platinum-loading amount of 14.7 g; hereinafter the same) for 120 minutes, and then dried. Then, in the same manner, the catalyst substrate was soaked in 28.4 g of vanadium acetate solution, and then in 12 g of rhodium acetate solution, whereby 1.31 g/L of platinum, 1.31 g/L of vanadium and 0.35 g/L of rhodium were loaded on the catalyst coat layer. Then, the catalyst substrate was dried at 250° C. for 8 hours and calcined at 500° C. for 2 hours, thus obtaining a monolithic catalyst of Example 1.

### Example 2

120 ml of the same slurry as described in Example 1 was filled in a casing having a bottom diameter of 52.0 mm, a top diameter of 103 mm and a depth of 52.5 mm, and 270 g/L of a catalyst coat layer was formed in the same manner as in Example 1. Then, catalytic components were loaded on the catalyst coat layer, thus obtaining a monolithic catalyst of Example 2.

### Comparative Example 1

Comparative Example 1 is a prior monolithic catalyst having a uniform catalyst coat layer throughout a monolithic catalyst substrate.

300 g of alumina sol (alumina content: 50 wt %), 125 g of 40% aluminum sulfate aqueous solution and 135 ml of water were mixed with each other to prepare a slurry for forming a catalyst coat layer. The viscosity of the slurry was 3500 mPa·s.

Then, the same monolithic catalyst substrate as described in Examples of the present invention was soaked in the slurry to attach the slurry to the inner surface of the cells of the catalyst substrate, then taken out of the slurry, and an excess of the slurry was removed by air blow. Then, the catalyst substrate was dried and calcined in the same manner as in Examples, thus forming a uniform catalyst coat layer through the monolithic catalyst substrate. In addition, the formed catalyst coat layer had a coating amount of 270 g/L.

Subsequently, catalytic components were loaded on the catalyst coat layer in the same manner as in Examples, thus obtaining a monolithic catalyst of Comparative Example 1 in which 1.5 g/L of platinum, 1.5 g/L of vanadium and 0.4 g/L of rhodium were loaded uniformly throughout the catalyst.

### (Evaluation)

The monolithic catalysts produced in Examples and Comparative Example, respectively, were tested for purification performance after an endurance test. The endurance test was carried out in the following conditions: air-to-fuel ration (A/F): catalyst temperature: 720° C.; and operating time: 300 hours. Then, when the temperature of exhaust gas reached 500° C., the hydrocarbon purification ratio was measured, and the measured value was evaluated as purification performance. In addition, each of the coating amount of the catalyst coat layer in the axial center region, Va (g/L), and the coating amount of the catalyst coat layer in the peripheral region, Vb (g/L), was measured. The measured results are shown in Table 1.

TABLE 1

| | COATING | | | |
|---|---|---|---|---|
| | AMOUNT (g/L) | | | PURIFICATION |
| | Va | Vb | Va/Vb | RATIO (%) |
| EXAMPLE 1 | 204 | 66 | 3.1 | 98 |
| EXAMPLE 2 | 164 | 106 | 1.5 | 94 |
| COMPARATIVE | 135 | 135 | 1.0 | 92 |
| EXAMPLE 1 | | | | |

As can be seen in Table 1, in Example 1, the coating amount (Va) of the catalyst coat layer in the axial center region was about 3-fold larger than the coating amount (Vb) of the catalyst coat layer in the peripheral region, and in Example 2, it was about 1.5-fold larger. Also, the hydrocarbon purification ratio was 98% in Example 1 and 94% in Example 2, which were higher than 92% in Comparative Example. Accordingly, it was confirmed that the monolithic catalysts of Examples had high purification performance compared to Comparative Example as a result of increasing the coating amount of the catalyst coat layer in the axial center region compared to that in the peripheral region, even though the total coating amount of the catalyst coat layer was the same between Examples and Comparative Examples. In addition, it was seen that, even when the loading amount of catalytic components in Examples was smaller than that in Comparative Example, the monolithic catalysts of Examples achieved purification performance approximately equal to that of Comparative Example.

As described above, according to the present invention, it is possible to produce a monolithic catalyst which has excellent purification performance while having a catalyst coat layer in the same coating amount as that of the prior catalyst coat layer. This is because, by reducing disadvantages, including excessive coating amount in the peripheral region or deficient coating amount in the axial center region, the loaded catalytic components is allowed to function effectively,

### INDUSTRIAL APPLICABILITY

The present invention is preferably employed as a monolithic catalyst for purifying automobile exhaust gas.

While the invention has been shown and described with reference to preferred embodiments thereof, it will be understood by those skilled in the art that various changes and modification may be made without departing from the spirit and scope of the invention as defined in the following claims.

What is claimed is:

1. A method for producing a monolithic catalyst, comprising a process of forming a catalyst coat for carrying catalytic components on the inner surfaces of cells of a substrate, is disposed downstream of an exhaust pipe for discharging exhaust gas, and includes a large number of cells extending in the axial direction and has a rod shape,
wherein the process of forming the catalytic coat comprises forming a catalyst coat layer in the axial center region of the substrate, includes the axial center of the exhaust pipe and has a lower end corresponding to the projected plane of the cross-section of the exhaust pipe, in an amount larger than in a peripheral region other than the axial center region of the substrate.

2. A method as set forth in claim 1, wherein the process of forming the catalytic coat comprises maintaining a slurry for forming the catalyst coat layer in an approximately truncated conical shape that has an upper side corresponding to the projected plane of the cross-section of the exhaust pipe and a lower side corresponding to the projected plane of the cross-section of the substrate, bringing one end of the substrate into close contact with the lower side of the slurry and sucking the slurry from the other end of the substrate.

3. A method as set forth in claim 1, wherein the process of forming the catalytic coat comprises disposing a resistive material, and restricts the introduction of the slurry into the peripheral region, between a slurry for forming the catalyst coat layer and one end of the substrate, and sucking the slurry from the other end of the substrate.

4. A method as set forth in claim 3, wherein the resistive material is a net material having a hole portion resembling the projected plane of the cross-section of the exhaust pipe.

5. A method as set forth in claim 3, wherein the resistive material is a plate material, which includes a hole portion resembling the projected plane of the cross-section of the exhaust pipe and can be separated into parts depending on the diameter of the hole portion.

6. A method as set forth in claim 2 or 3, wherein the viscosity of the slurry is 2000-10000 mP·s.

7. A method as set forth in claim 2 or 3, wherein negative suction pressure for sucking the slurry is 1-30 atm.

8. A monolithic catalyst produced according to a method as set forth in claim 1.
